(19) United States
(12) Patent Application Publication
(10) Pub. No.: US 2023/0178804 A1
(43) Pub. Date: Jun. 8, 2023

(54) PROCESSES FOR PRODUCING LITHIUM BIS(FLUOROSULFONYL) IMIDE

(71) Applicant: Honeywell International Inc., Charlotte, NC (US)

(72) Inventors: Thomas Potrawa, Seelze (DE); Jessica Maurer, Wunstorf (DE); Michael Kessler, Neustadt (DE); Christian Werner, Hannover (DE); Anke Zenker, Seelze (DE)

(21) Appl. No.: 17/992,680

(22) Filed: Nov. 22, 2022

Related U.S. Application Data
(60) Provisional application No. 63/285,303, filed on Dec. 2, 2021.

(51) Int. Cl. H01M 10/0567; H01M 10/0525; C01B 21/086

(52) U.S. Cl. CPC H01M 10/0567; H01M 10/0525; C01B 21/086; H01M 2300/0025; C01P 2006/40

(57) ABSTRACT

A process for producing high purity lithium bis(fluorosulfonyl) imide includes contacting bis(fluorosulfonyl) imide with a lithium salt, followed by purification and drying of lithium bis(fluorosulfonyl) imide.

### CROSS-REFERENCE TO RELATED APPLICATION

This application claims priority to U.S. Provisional Application No. 63/285,303, filed Dec. 2, 2021, which is herein incorporated by reference in its entirety.

### FIELD

The present disclosure relates to processes for producing lithium bis(fluorosulfonyl) imide (LiFSI) from bis(fluorosulfonyl) imide (HFSI). Specifically, the present disclosure relates to processes for producing lithium bis(fluorosulfonyl) imide with low concentrations of both chloride and water.

### BACKGROUND

Bis(fluorosulfonyl) imide (HFSI) is a key raw material in the production of lithium bis(fluorosulfonyl) imide (LiFSI), which is used in lithium ion batteries. HFSI can be prepared by several methods. For example, HFSI can be prepared by the reaction of urea with fluorosulfonic acid shown in Equation 1:

5HSO₃F+2CO(NH₂)₂→HN(SO₂F)₂+2CO₂+3NH₄SO₃F. Eq. 1

U.S. Pat. No. 8,337,797 to Honda et al. discloses a two-step batch process for producing HFSI from urea and fluorosulfonic acid. In the first step, the urea is dissolved in the fluorosulfonic acid at a temperature low enough to prevent the reaction of Equation 1 between the urea and the fluorosulfonic acid. In the second step, the urea/fluorosulfonic acid solution is slowly added to separate reaction vessel including a reaction medium heated sufficiently for the reaction of Equation 1 to proceed. The controlled addition permits the heat generated by the exothermic reaction of Equation 1 to be controlled. U.S. Pat. No. 8,337,797 discloses that the heated reaction medium can be fluorosulfonic acid or HFSI, but it is preferable to use a mixture of fluorosulfonic acid and HFSI, with the HFSI serving to further control the reaction, especially at the beginning, when the urea/fluorosulfonic acid solution is first added to the heated reaction medium.

International publication WO2011/111780, also to Honda et al., further discloses a recovery process to continuously remove reaction liquid from the reaction vessel, such as through an overflow outlet, continuously discharging the reaction liquid in a slurry state (including the ammonium salt byproduct). The process disclosed is done in production batches, with product HFSI added back to the reaction vessel ahead of the reaction for the next production batch.

International publication WO 2017/204225 discloses the reaction of HFSI with alkali metal compounds. International publication WO 2017/204302 also discloses combining HFSI with alkali metal compounds in an organic solvent. U.S. Pat. No. 10,505,228 discloses the production of LiFSI with low water concentration. And Han et al., Journal of Power Sources, vol. 196, pp. 3623-3632 discloses LiFSI with low water and chloride content, although does not disclose a process to prepare said product.

There is a need for a process to prepare LiFSI with low water and chloride content, and there is a need for a composition of LiFSI with low water and chloride content.

### SUMMARY

The present disclosure provides a process to produce lithium bis(fluorosulfonyl)imide (LiFSI) comprising a) treating hydrogen bis(fluorosulfonyl)imide (HFSI) with a lithium salt in a first solvent to produce lithium bis(fluorosulfonyl)imide (LiFSI) and water; and b) drying the lithium bis(fluorosulfonyl)imide (LiFSI) with a halogenated hydrocarbon solvent to produce a lithium bis(fluorosulfonyl)imide (LiFSI) product. The present disclosure further provides lithium bis(fluorosulfonyl)imide (LiFSI) with low water and chloride content. Specifically, the present disclosure provides lithium bis(fluorosulfonyl)imide (LiFSI) with a water content of less than 180 ppm and a chloride content of less than 5 ppm. The present disclosure also provides a process for producing lithium bis(fluorosulfonyl)imide (LiFSI) with low water and chloride content.

The above mentioned and other features of the disclosure, and the manner of attaining them, will become more apparent and will be better understood by reference to the following description of embodiments taken in conjunction with the accompanying drawings.

### DESCRIPTION OF THE DRAWINGS

FIG. 1 shows a laboratory scale process for the production of lithium bis(fluorosulfonyl) imide LiFSI, according to some embodiments of this disclosure.

FIG. 2 shows an industrial scale process for the production of lithium bis(fluorosulfonyl) imide LiFSI, according to some embodiments of this disclosure.

FIG. 3 shows percent yield of LiFSI precipitation as a function of the ratio of dichloromethane:LiFSI, as described in Example 4.

### DETAILED DESCRIPTION

The present disclosure provides a process to produce lithium bis(fluorosulfonyl) imide (LiFSI) from bis(fluorosulfonyl) imide (HFSI). As described further below, HFSI may be produced from a solution of urea and fluorosulfonic acid.

I. Synthesis of HFSI

The solution of urea and fluorosulfonic acid is formed by mixing the urea and the fluorosulfonic acid together a solution temperature low enough to substantially prevent the reaction of the urea and the fluorosulfonic acid as shown in Equation 1, but high enough for the efficient dissolution of the urea suitable for a commercial process. The solution temperature may be as low as about 0° C., about 5° C., about 10° C., about 15° C., about 20° C., about 25° C., about 30° C. or about 35° C., or as high as about 40° C., about 45° C., about 50° C., about 55° C., about 60° C., about 65° C. or about 70° C., or within any range defined between any two of the foregoing values, such as about 0° C. to about 70° C., about 5° C. to about 65° C., about 10° C. to about 60° C., about 15° C. to about 55° C., about 20° C. to about 50° C., about 25° C. to about 45° C., about 30° C. to about 40° C., about 35° C. to about 55° C., about 40° C. to about 50° C., or about 25° C. to about 65° C., for example. Preferably, the solution temperature is from about 25° C. to about 60° C. More preferably, the solution temperature is from about 30° C. to about 55° C. Most preferably, the solution temperature is from about 30° C. to about 50° C.

A mole ratio of fluorosulfonic acid to urea in the solution of urea and fluorosulfonic acid should be high enough for fluorosulfonic acid to dissolve all of the urea to create a homogenous, liquid-phase solution, rather than a slurry including undissolved urea which can make transporting the solution more difficult. However, adding too much fluorosulfonic acid reduces the efficiency of the process by requiring larger systems and increased energy to handle transport the solution and later separate the excess fluorosulfonic acid from the HFSI. Thus, the mole ratio of fluorosulfonic acid to urea in the solution may be as low as about 2.0:1, about 2.1:1, about 2.2:1, about 2.3:1, about 2.4:1 or about 2.5:1, or as high as about 2.6:1, about 2.7:1, about 2.8:1, about 2.9:1, or about 3.0:1, or within any range defined between any two of the foregoing values, such as about 2.0:1 to about 3.0:1, about 2.1:1 to about 2.9:1, about 2.2:1 to about 2.8:1, about 2.3:1 to about 2.7:1, about 2.4:1 to about 2.6:1, about 2.5:1 to about 2.6:1, about 2.4:1 to about 2.7:1, about 2.4:1 to about 2.5:1 or about 2.6:1 to about 2.8:1, for example. Preferably, the mole ratio of fluorosulfonic acid to urea in the solution is from about 2.2:1 to about 2.8:1. More preferably, the mole ratio of fluorosulfonic acid to urea in the solution is from about 2.3:1 to about 2.7:1. Most preferably, the mole ratio of fluorosulfonic acid to urea in the solution is from about 2.4:1 to about 2.6:1.

The solution of urea and fluorosulfonic acid is added to a reaction medium at a reaction temperature to react the fluorosulfonic acid and the urea to produce a product stream including HFSI, as well as ammonium fluoride, as shown in Equation 1. The carbon dioxide gas produced may be vented or captured for other uses. The reaction medium includes fluorosulfonic acid. The reaction medium may further include HFSI.

The reaction medium heats the solution of urea and fluorosulfonic acid and helps to control the reaction. In some embodiments, a weight ratio of reaction medium to the solution of urea and fluorosulfonic acid may be as low as about 0.1:1, about 0.2:1, about 0.3:1, about 0.4:1, about 0.5:1, about 0.6:1 or about 0.8:1, or as high as about 1:1, about 2:1, about 4:1, about 6:1, about 8:1, or about 10:1, or within any range defined between any two of the foregoing values, such as about 0.1:1 to about 10:1, about 0.2:1 to about 8:1, about 0.3:1 to about 6:1, about 0.4:1 to about 4:1, about 0.6:1, to about 2:1, about 0.8:1 to about 1:1, about 0.4:1 to about 1:1, or about 0.6:1 to about 0.8:1, for example.

In some embodiments, the weight ratio of the reaction medium to the solution of urea and fluorosulfonic acid is high enough to completely dissolve the reaction byproducts, including the ammonium fluorosulfate, so as to prevent the need to handle a slurry. Thus, in some embodiments in which the ammonium fluorosulfate is completely dissolved, preferably, the weight ratio of the reaction medium to the solution of urea and fluorosulfonic acid is from about 0.3:1 to about 2:1. More preferably, the weight ratio of the reaction medium to the solution of urea and fluorosulfonic acid is from about 0.4:1 to about 1:1. Most preferably, the weight ratio of the reaction medium to the solution of urea and fluorosulfonic acid is from about 0.6:1 to about 0.8:1.

However, increasing the amount of reaction medium reduces the efficiency of the process to the extent that it requires larger systems and increased energy usage to separate the HFSI product from the reaction medium. Thus, in some embodiments, it is desirable to use a lower weight ratio of the reaction medium to the solution of urea and fluorosulfonic acid, resulting in the formation of a slurry including undissolved ammonium fluorosulfate. In such embodiments, in which the ammonium fluorosulfate is not completely dissolved, preferably, the weight ratio of the reaction medium to the solution of urea and fluorosulfonic acid is from about 0.1:1 to about 0.6:1. More preferably, the weight ratio of the reaction medium to the solution of urea and fluorosulfonic acid is from about 0.1:1 to about 0.4:1. Most preferably, the weight ratio of the reaction medium to the solution of urea and fluorosulfonic acid is from about 0.1:1 to about 0.3:1.

The reaction temperature may be as low as about 80° C., about 90° C., about 100° C., about 110° C., or about 120° C., or as high as about 130° C., about 140° C., about 150° C., about 160° C. or about 170° C., or within any range defined between any two of the foregoing values, such as about 80° C. to about 170° C., about 90° C. to about 160° C., about 100° C. to about 150° C., about 110° C. to about 140° C., about 120° C. to about 130° C., about 130° C. to about 150° C., or about 110° C. to about 120° C., for example. Preferably, the reaction temperature is from about 110° C. to about 140° C. More preferably, the reaction temperature is from about 120° C. to about 140° C. Most preferably, the reaction temperature is from about 120° C. to about 130° C.

The ammonium fluorosulfate is separated from the product stream. The ammonium fluorosulfate may be separated by evaporation, filtration, or any combination thereof, for example.

The product stream is separated into a concentrated product stream and a first recycle stream. The concentrated product stream includes a higher concentration of the HFSI than the first recycle stream. In some embodiments, the first recycle stream is recycled back to the reaction medium. In some embodiments, the first recycle stream may alternatively, or additionally, be directed to a storage tank for later use. The separation may be by distillation, for example.

It has been found that adding HFSI to the reaction medium reduces the yield of the HFSI in the system. Thus, a concentration of HFSI in the first recycle stream is less than about 50 weight percent (wt. %), 40 wt. %, 30 wt. %, 20 wt. %, 10 wt. %, 5 wt. %, 3 wt. %, 2 wt. %, 1 wt. %, or 0.5 wt. %, or less than any value between any two of the foregoing values. Preferably, the concentration of HFSI in the first recycle stream is less than 20 wt. %. More preferably, the concentration of HFSI in the first recycle stream is less than 10 wt. %. Most preferably, the concentration of HFSI in the first recycle stream is less than 5 wt. %.

Optionally, the concentrated product stream may be separated into a further concentrated product stream and a second recycle stream. The further concentrated product stream includes a higher concentration of the HFSI than the second recycle stream. In some embodiments, the second recycle stream is recycled back to the reaction medium. Alternatively, or additionally, in some embodiments, the second recycle stream is directed to a storage tank for later use. The separation may be by distillation, for example.

In some embodiments, the processes described above are continuous processes. In some other embodiments, the processes described above are semi-batch. By semi-batch, it is meant that while significant portions of the process are continuous, the entire process is not continuous. For example, in some semi-batch embodiments, the product stream may be produced and stored in continuous fashion for some period of time, and then at a later time, the stored product stream may be processed through the separation steps to separate the ammonium fluorosulfate from the product stream, and to produce the concentrated product stream and a first recycle stream in a continuous fashion, with the concentrated product stream stored and the first recycle stream stored for later use as a reaction medium for the production of another product stream. In some other semi-batch embodiments, the intermediate product stream may be produced and stored in continuous fashion for some period of time, and then at a later time, the stored intermediate product stream may be processed through the separation step to produce the concentrated product stream and a first recycle stream in a continuous fashion, with the concentrated product stream stored and the first recycle stream stored for later use as a reaction medium for the production of another product stream.

II. Synthesis of LiFSI

The present disclosure provides a method of producing lithium bis(fluorosulfonyl) imide (LiFSI) from bis(fluorosulfonyl) imide (HFSI). The HFSI may be produced as described above. The HFSI may then be treated with a lithium salt to produce LiFSI and water, as shown in Equation 2 below, wherein lithium hydroxide is shown as the lithium salt.

HN(SO₂F)₂+LiOH→LiN(SO₂F)₂+H₂O Eq. 2

Suitable lithium salts may include lithium hydroxide (LiOH), lithium carbonate (Li₂CO₃), and lithium oxide (Li₂O), for example.

The lithium salt may be dissolved in a first solvent to form a suspension. Suitable first solvents may include dimethyl carbonate, diethyl carbonate, methyl ethyl ketone, ethyl acetate, and methyl isobutyl ketone, for example.

Following the formation of the suspension of the lithium salt in the first solvent, the HFSI may be added to the mixture. To prevent fuming of HFSI in an air atmosphere, the reaction mixture may be placed under an inert atmosphere, such as nitrogen or argon, for example, prior to the addition of HFSI.

Based on the molar amount of HFSI present in the reaction mixture, the lithium salt may be present in the reaction in an amount of about 0.5 equivalents or greater, about 0.6 equivalents or greater, about 0.7 equivalents or greater, about 0.8 equivalents or greater, about 0.9 equivalents or greater, about 1 equivalent or greater, about 1.1 equivalents or greater, about 1.2 equivalents of greater, about 1.3 equivalents or greater, about 1.4 equivalents or greater, about 1.5 equivalents or greater, about 1.6 equivalents or less, about 1.7 equivalents of less, about 1.8 equivalents or less, about 1.9 equivalents or less, about 2 equivalents or less, or any value encompassed by these endpoints.

The pH of the reaction mixture may be about 1.5 or greater, about 2.0 or greater, about 2.5 or less, about 3.0 or less, about 3.5 or less, or any value encompassed by these endpoints.

The reaction may be conducted at a temperature of about 35° C. or less, about 30° C. or less, about 25° C. or less, about 20° C. or less, about 15° C. or less, about 10° C. or less, about 5° C. or less, or about 0° C. or less.

The reaction may be conducted for a period of time of about 60 minutes or greater, about 80 minutes or greater, about 100 minutes or greater, about 120 minutes or greater, about 140 minutes or greater, about 160 minutes or less, about 180 minutes or less, about 200 minutes or less, about 220 minutes or less, about 240 minutes or less, or any value encompassed by these endpoints.

Following the initial stir time, the reaction mixture may comprise LiFSI, the first solvent, and water, based on the molar amount of LiFSI, as well as residual HFSI and lithium salt. The mixture of LiFSI, water, and the first solvent may then be stirred for a further period of time of about 30 minutes or more, about 1 hour or more, about 2 hours of more, about 5 hours or more, about 8 hours or more, about 12 hours or more, about 14 hours or less, about 16 hours or less, about 18 hours or less, about 20 hours or less, about 22 hours or less, about 24 hours or less, or any value encompassed by these endpoints.

During this stirring time, the reaction temperature may be about 15° C. or greater, about 20° C. or greater, about 25° C. or greater, about 30° C. or less, about 35° C. or less, about 40° C. or less, or any value encompassed by these endpoints.

During this stirring time, the pH of the reaction may be about 5.0 or greater, about 5.5 or greater, about 6.0 or greater, about 6.5 or less, about 7.0 or greater, or any value encompassed by these endpoints.

Following this stirring time, reaction mixture may be filtered. Following filtration, the remaining solution may be further purified to remove water. Without wishing to be bound by theory, the addition of further solvent, such as diethyl carbonate, may aid in the removal of water. To remove the water, the mixture comprising LiFSI, water, and solvent, may be subjected to distillation. Suitable distillation methods include azeotropic distillation, for example.

Azeotropic distillation may be conducted at a pressure of about 60 mbar or less, about 55 mbar or less, about 50 mbar or less, about 45 mbar or less, about 40 mbar or less, about 35 mbar or less, about 30 mbar or less, about 25 mbar or greater, about 20 mbar or greater, about 15 mbar or greater, about 10 mbar or greater, about 5 mbar or greater, or any value encompassed by these endpoints.

The azeotropic distillation may be conducted using a pressure ramp. For example, the pressure may be decreased from about 45 mbar to about 15 mbar over the course of the distillation.

The azeotropic distillation may be conducted at a temperature of about 35° C. or greater, about 40° C. or greater, about 45° C. or greater, about 50° C. or less, about 55° C. or less, about 60° C. or less, about 65° C. or less, about 70° C. or less, or any value encompassed by these endpoints.

The azeotropic distillation may be conducted using a temperature ramp. For example, the temperature may be increased from about 40° C. to about 60° C. over the course of the distillation.

Following azeotropic distillation, the LiFSI may still contain traces of water. To remove residual water from the LiFSI, the mixture comprising LiFSI, the first solvent, and water may be subjected to a second distillation step. Prior to the second distillation step, a second solvent may be added. Suitable second solvents may include xylenes, toluene, ethyl benzene, dimethyl benzene, and mesitylene, for example.

The mixture comprising LiFSI, the first solvent, the second solvent, and water may be subjected to distillation at a pressure of about 60 mbar or less, about 55 mbar or less, about 50 mbar or less, about 45 mbar or less, about 40 mbar or less, about 35 mbar or less, about 30 mbar or less, about 25 mbar or greater, about 20 mbar or greater, about 15 mbar or greater, about 10 mbar or greater, about 5 mbar or greater, or any value encompassed by these endpoints.

The distillation may be conducted using a pressure ramp. For example, the pressure may be decreased from about 45 mbar to about 10 mbar over the course of the distillation.

The distillation may be conducted at a temperature of about 40° C. or greater, about 45° C. or greater, about 50° C. or less, about 55° C. or less, about 60° C. or less, about 65° C. or less, about 70° C. or less, or any value encompassed by these endpoints.

The distillation may be conducted using a temperature ramp. For example, the temperature may be increased from about 50° C. to about 60° C. over the course of the distillation.

The LiFSI may then be purified by precipitation. A third solvent may be added to the mixture comprising LiFSI, the first solvent, and trace water. A suitable third solvent may comprise a halogenated hydrocarbon, such as dichloromethane (DCM), dichloroethane (DCE), chloroform (CHCl₃), bromoform (CHBr₃), carbon tetrachloride (CCI₄), carbon tetrabromide (CBr₄), and methyl iodide (CH₃I), for example.

The weight ratio (w/w) of LiFSI to DCM may be about 1:1 w/w or greater, about 1:1.5 w/w or greater, about 1:2 w/w or greater, about 1:2.5 w/w or greater, about 1:3 w/w or less, about 1:3.5 or less w/w, about 1:4 or less w/w, or any value encompassed by these endpoints. In an embodiment, the weight ratio of LiFSI to DCM is 1:2 (w/w).

Once the LiFSI is precipitated, it may be further purified by pressure filtration while washing with the third solvent. The resultant solid LiFSI may then be dried. If desired, the drying may be conducted inside a glovebox. The solid LiFSI may be dried over multiple steps. For example, the solid LiFSI may first be dried at ambient temperature and pressure, followed by drying under vacuum. Alternatively, the solid LiFSI may be dried in one step.

The solid LiFSI may then be dried at a temperature of about 15° C. or greater, about 20° C. or greater, about 25° C. or greater, about 30° C. or less, about 35° C. or less, or any value encompassed by these endpoints.

The solid LiFSI may be dried at a pressure of about 1 mbar or greater, about 5 mbar or greater, about 10 mbar or greater, about 15 mbar or less, about 20 mbar or less, about 25 mbar or less, or any value encompassed by these endpoints.

The LiFSI may be dried for a period of time of about 12 hours or greater, about 18 hours or greater, about 24 hours or greater, about 30 hours of greater, about 36 hours or less, about 40 hours or less, about 48 hours or less, or any value encompassed by these endpoints.

The yield of the reaction may be about 65% or greater, about 70% or greater, or about 75% or greater, based on the starting amount of HFSI.

The amount of water present in the dried LiFSI may be about 200 ppm or less, about 180 ppm or less, about 150 ppm or less, about 120 ppm or less, about 100 ppm or less, about 80 ppm or less, about 50 ppm or less, about 40 ppm or less, about 30 ppm or less, about 20 ppm or less, or about 10 ppm or less, or any value or range encompassed by these endpoints, as measured by Karl Fischer titration.

For example, the amount of water present in the dried LiFSI may be between about 10 ppm and about 200 ppm; between about 40 ppm and about 120 ppm; between about 50 ppm and about 80 ppm; between about 20 ppm and about 50 ppm; or between about 20 ppm and 180 ppm.

The amount of chloride ions present in the dried LiFSI may be about 10 ppm or less, about 5 ppm or less, about 4 ppm or less, about 3 ppm or less, about 2 ppm or less, or about 1 ppm or less, 500 ppb or less, 250 ppb or less, 100 ppb or less, 10 ppb or less, 5 ppb or less, 1 ppb or less, or any value or range encompassed by these endpoints, as determined by nephelometry using a Turbidimeter 2100AN.

For example, the amount of chloride ions present in the dried LiFSI may be between about 1 ppm and about 10 ppm; between about 2 ppm and about 4 ppm; between about 1 ppm and about 5 ppm; between about 1 ppm and about 2 ppm, between about 1 ppb and 500 ppb; between about 5 ppb and 1 ppm; or between about 10 ppb and 250 ppb.

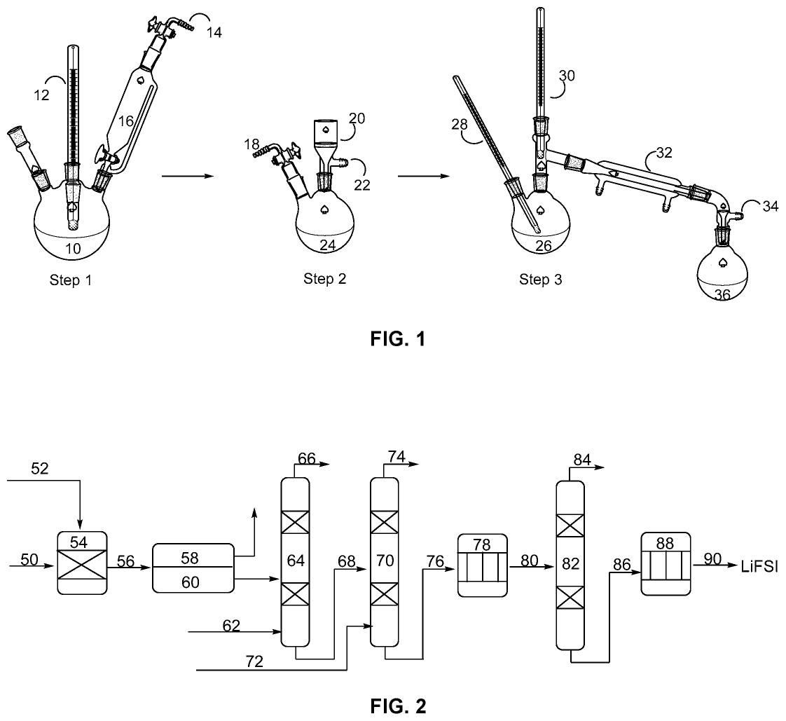

An overview of a laboratory scale process to produce LiFSI in the manner described herein is shown in FIG. 1. In this method, in Step 1, a mixture 10 of LiOH in diethyl carbonate is placed under inert atmosphere through an inlet 14. HFSI may then be added to the mixture of LiOH in diethyl carbonate via addition funnel 16. In Step 2, following the reaction the mixture may be filtered through a fritted funnel 20 connected to a vacuum line 22 to provide a mixture 24 of LiFSI, diethyl carbonate, and water. In Step 3, the mixture may then be combined with xylene and subjected to azeotropic distillation to provide a distillate 36 comprising diethyl carbonate, water, and xylene, as well as a solution 26 comprising LiFSI. In Step 4 (not shown), a solvent, such as a halogenated hydrocarbon solvent, may be added to precipitate the LiFSI. Finally, in Step 5 (not shown) the LiFSI may be isolated with a pressure filter under inert atmosphere and dried at room temperature under inert gas for approximately 45 minutes, and then under reduced pressure (5 mbar) at maximum temperature of 50° C.

An overview of an industrial scale process is shown in FIG. 2. A stream 50 comprising a lithium salt such as lithium hydroxide in a first solvent such as diethyl carbonate (DEC) may be passed to a reactor 54. A stream 52 comprising liquid HFSI may be added to the reactor 54 to provide a crude product stream 56 comprising LiFSI, the first solvent, and water. The stream 56 may then undergo filtration to remove any solids that remain (for example that may have come in with the lithium source). The filtered residue is stream 58, while the filtrate stream 60 comprising LiFSI, the first solvent and water may be passed to a first distillation column 64. Additional dry first solvent 62 may be added, and the mixture may undergo azeotropic distillation. A first overhead product 66 comprising water and the first solvent may be removed, and a first bottoms product 68 comprising LiFSI, residual first solvent and residual water may be passed to a second column 70, and a dry second solvent 72, such as xylene, may be added. The mixture may undergo azeotropic distillation to provide a second overhead product 74 comprising the first and second solvents and water. The second bottoms product 76 comprising LiFSI residual first solvent and residual water may be filtered 78 to remove impurities, providing a stream 80 comprising LiFSI residual first solvent and residual water. Optionally Stream 80, may be passed to a third distillation column 82 to remove residual solvent as the third overhead product 84, leaving a third bottoms product stream 86. Either stream 80 or optionally stream 86 may be combined with a third solvent (such as dichloromethane (DCM) to precipitate LiFSI (not shown) and then passed to a filter 88 to provide a purified product stream 90 comprising solid LiFSI, which may be further dried (not shown) to provide the desired product.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value. As used herein, the singular forms “a”, “an” and “the” include plural unless the context clearly dictates otherwise. Ranges do not include zero unless stated otherwise.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

### EXAMPLES

### Example 1: Synthesis of LiFSI

Lithium hydroxide was added to diethyl carbonate at room temperature and placed under an inert atmosphere. HFSI was then added, and the mixture was stirred for two hours at 35° C. The mixture was then cooled to room temperature and stirred overnight. The mixture was then filtered to provide a clear solution containing approximately 30% LiFSI.

### Example 2: Azeotropic Distillation of LiFSI

To the solution of LiFSI, diethyl carbonate, and water, was added additional diethyl carbonate to provide a clear solution containing approximately 17% LiFSI. The mixture was then subjected to azeotropic distillation under increasing vacuum, from 45 mbar to 15 mbar. The temperature was increased from 40° C. to 60° C. The azeotropic distillation was allowed to continue for approximately 8 hours, after which a solution of LiFSI in diethyl carbonate was recovered.

### Example 3: Purification of LiFSI

To a solution of LiFSI in diethyl carbonate was added xylenes. The mixture was then subjected to distillation under increasing vacuum, from 45 mbar to 10 mbar. The temperature was maintained between 50° C. and 60° C. to provide a concentrated solution of LiFSI in diethyl carbonate.

To the concentrated solution of LIFSI solution in diethyl carbonate was added an excess of dichloromethane to precipitate the LiFSI. The mixture was then filtered via pressure filtration in a glovebox, while washing with dichloromethane. The recovered LiFSI was first dried for 45 min at room temperature, then for 24 hours at a pressure of 5 mbar to provide LiFSI in 70% yield based on the amount of HFSI, with a water content of 26 ppm and a chloride content of less than 5 ppm. The water content and chloride content were determined by Karl Fisher titration/ion chromatography. Nephelometry with a Turbidimeter 2100AN may also be used.

### Example 4: Precipitation of LiFSI

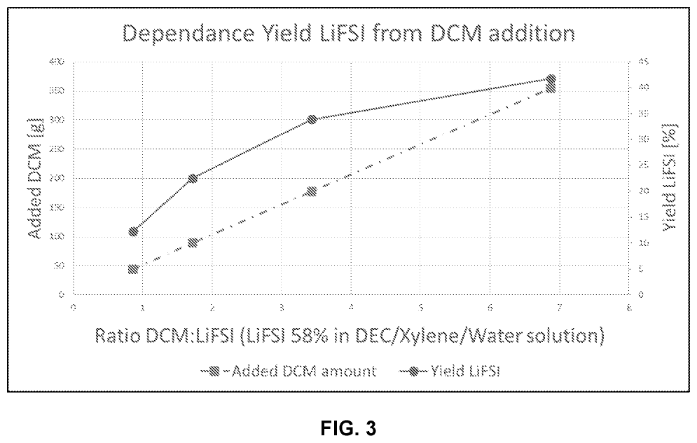

To optimize the precipitation of LiFSI from a 58% solution of LiFSI in diethyl carbonate and xylenes, four different ratios of dichloromethane to LiFSI were tested. The results are shown in FIG. 3. As can be seen therein, the yield of LiFSI increases as the amount of dichloromethane increases; however, the increase is not linear. A ratio of 3.5:1 dichloromethane: LiFSI was selected as the optimal ratio.

### Example 5: Removal of Chloride from LiFSI

LiFSI synthesis was conducted using HFSI contaminated by chloride (from HCISI). The contaminated HFSI contained 150 ppm chloride by weight. The synthesis was performed using the procedures described in the above Examples. The precipitated LiFSI (35% yield) had a chloride content of between 10-20 ppm (via Nephelometry). A second run provided LiFSI in 49% yield, with a chloride content of 10-20 ppm.

### Example 6: Analysis of Purified LiFSI

The purified LiFSI was then analyzed by ICP and AAS for metal content. The amount of chloride was also determined. The amount of sulfate was analyzed via IC, and the amount of chloride was determined via turbidity. The results are shown in Table 1 below.

TABLE 1

| Component | Run 1 (ppm) | Run 2 (ppm) | Run 3 (ppm) | Run 4 (ppm) |
|---|---|---|---|---|
| Water | 130 | 180 | 26 | 45 |
| Arsenic | <5 | <5 | <5 | <5 |
| Calcium | <1 | <1 | <1 | <1 |
| Cadmium | <1 | <1 | <1 | <1 |
| Chromium | <1 | <1 | <1 | <1 |
| Copper | <1 | <1 | <1 | <1 |
| Iron | <1 | <1 | <1 | <1 |
| Potassium | <4 | <4 | <4 | <4 |
| Magnesium | <0.5 | <0.5 | <0.5 | <0.5 |
| Sodium | <4 | <4 | <4 | <4 |
| Nickel | <5 | <5 | <5 | <5 |
| Lead | <5 | <5 | <5 | <5 |
| Zinc | <0.5 | <0.5 | <0.5 | <1 |
| Chloride | <5 | <5 | <5 | <5 |
| Sulfate | 20 | >50 | Not measured | Not measured |

### ASPECTS

Aspect 1 is a process to produce lithium bis(fluorosulfonyl)imide (LiFSI), the process comprising: a) treating hydrogen bis(fluorosulfonyl)imide (HFSI) with a lithium salt in a first solvent to produce lithium bis(fluorosulfonyl)imide (LiFSI) and water; and b) drying the lithium bis(fluorosulfonyl)imide (LiFSI) with a halogenated hydrocarbon solvent, to produce a lithium bis(fluorosulfonyl)imide (LiFSI) product.

Aspect 2 is the process of Aspect 1, wherein the lithium salt comprises lithium hydroxide (LiOH).

Aspect 3 is the process of either Aspect 1 or Aspect 2, wherein the first solvent comprises diethyl carbonate.

Aspect 4 is the process of any one of Aspects 1 to 3, further comprising azeotropic distillation of the first solvent to produce a biphasic distillate comprising lithium bis(fluorosulfonyl)imide (LiFSI), the first solvent, and water.

Aspect 5 is the process of Aspect 4, further comprising performing the azeotropic distillation.

Aspect 6 is the process of Aspect 5, further comprising increasing the vacuum during the azeotropic distillation from 45 mbar to 15 mbar.

Aspect 7 is the process of any one of Aspects 4 to 6, further comprising adding a second solvent to the biphasic distillate.

Aspect 8 is the process of Aspect 7, wherein the second solvent comprises xylenes.

Aspect 9 is the process of Aspect 8, further comprising distilling the mixture of xylenes, lithium bis(fluorosulfonyl)imide (LiFSI), the first solvent, and water to provide a monophasic distillate.

Aspect 10 is the process of any one of Aspects 1 to 9, further comprising adding a third solvent to produce the dry lithium bis(fluorosulfonyl)imide (LiFSI) product.

Aspect 11 is the process of Aspect 10, wherein the third solvent comprises dichloromethane (DCM).

Aspect 12 is the process of Aspect 11, wherein the weight/weight (w/w) ratio of lithium bis(fluorosulfonyl)imide (LiFSI) to dichloromethane (DCM) is 1:1 to 1:4.

Aspect 13 is the process of Aspect 12, wherein the weight/weight (w/w) ratio of lithium bis(fluorosulfonyl)imide (LiFSI) to dichloromethane (DCM) is 1:2.

Aspect 14 is the process of any one of Aspects 1 to 13, wherein the water content of the lithium bis(fluorosulfonyl)imide (LiFSI) product is 180 ppm or less.

Aspect 15 is a process to produce lithium bis(fluorosulfonyl)imide (LiFSI), the process comprising: a) treating hydrogen bis(fluorosulfonyl)imide (HFSI) having a chloride ion content of 5 ppm or less with a lithium salt in a first solvent to produce lithium bis(fluorosulfonyl)imide (LiFSI) and water; and b) drying the lithium bis(fluorosulfonyl)imide (LiFSI) product.

Aspect 16 is the process of Aspect 15, wherein the lithium salt comprises lithium hydroxide (LiOH).

Aspect 17 is the process of either Aspect 15 or Aspect 16, wherein the lithium bis(fluorosulfonyl)imide (LiFSI) product contains less than 180 ppm water.

Aspect 18 is a process to produce lithium bis(fluorosulfonyl)imide (LiFSI), the process comprising: a) treating hydrogen bis(fluorosulfonyl)imide (HFSI) comprising less than 5 ppm chloride with a lithium salt in a first solvent to produce lithium bis(fluorosulfonyl)imide (LiFSI) and water; and b) drying the lithium bis(fluorosulfonyl)imide (LiFSI), to produce a lithium bis(fluorosulfonyl)imide (LiFSI) product.

Aspect 19 is the process of Aspect 15, wherein the lithium bis(fluorosulfonyl) imide (LiFSI) product contains less than 180 ppm water and less than 5 ppm chloride.

Aspect 20 is lithium bis(fluorosulfonyl) imide (LiFSI), comprising less than 5 ppm chloride and less than 180 ppm water.

1. A process to produce lithium bis(fluorosulfonyl)imide (LiFSI), the process comprising:
a) treating hydrogen bis(fluorosulfonyl)imide (HFSI) with a lithium salt in a first solvent to produce lithium bis(fluorosulfonyl)imide (LiFSI) and water; and
b) drying the lithium bis(fluorosulfonyl)imide (LiFSI) with a halogenated hydrocarbon solvent, to produce a lithium bis(fluorosulfonyl)imide (LiFSI) product.

2. The process of claim 1, wherein the lithium salt comprises lithium hydroxide (LiOH).

3. The process of claim 1, wherein the first solvent comprises diethyl carbonate.

4. The process of claim 1, further comprising azeotropic distillation of the first solvent to produce a biphasic distillate comprising lithium bis(fluorosulfonyl)imide (LiFSI), the first solvent, and water.

5. The process of claim 4, further comprising performing the azeotropic distillation.

6. The process of claim 5, further comprising increasing the vacuum during the azeotropic distillation from 45 mbar to 15 mbar.

7. The process of claim 4, further comprising adding a second solvent to the biphasic distillate.

8. The process of claim 7, wherein the second solvent comprises xylenes.

9. The process of claim 8, further comprising distilling the mixture of xylenes, lithium bis(fluorosulfonyl)imide (LiFSI), the first solvent, and water to provide a monophasic distillate.

10. The process of claim 1, further comprising adding a third solvent to produce the dry lithium bis(fluorosulfonyl)imide (LiFSI) product.

11. The process of claim 10, wherein the third solvent comprises dichloromethane (DCM).

12. The process of claim 11, wherein the weight/weight (w/w) ratio of lithium bis(fluorosulfonyl)imide (LiFSI) to dichloromethane (DCM) is 1:1 to 1:4.

13. The process of claim 12, wherein the weight/weight (w/w) ratio of lithium bis(fluorosulfonyl)imide (LiFSI) to dichloromethane (DCM) is 1:2.

14. The process of claim 1, wherein the water content of the lithium bis(fluorosulfonyl)imide (LiFSI) product is 180 ppm or less.

15. A process to produce lithium bis(fluorosulfonyl)imide (LiFSI), the process comprising:
a) treating hydrogen bis(fluorosulfonyl)imide (HFSI) having a chloride ion content of 5 ppm or less with a lithium salt in a first solvent to produce lithium bis(fluorosulfonyl)imide (LiFSI) and water; and
b) drying the lithium bis(fluorosulfonyl)imide (LiFSI) product.

16. The process of claim 15, wherein the lithium salt comprises lithium hydroxide (LiOH).

17. The process of claim 15, wherein the lithium bis(fluorosulfonyl)imide (LiFSI) product contains less than 180 ppm water.

18. A process to produce lithium bis(fluorosulfonyl)imide (LiFSI), the process comprising:
a) treating hydrogen bis(fluorosulfonyl)imide (HFSI) comprising less than 5 ppm chloride with a lithium salt in a first solvent to produce lithium bis(fluorosulfonyl)imide (LiFSI) and water; and
b) drying the lithium bis(fluorosulfonyl)imide (LiFSI), to produce a lithium bis(fluorosulfonyl)imide (LiFSI) product.

19. The process of claim 15, wherein the lithium bis(fluorosulfonyl) imide (LiFSI) product contains less than 180 ppm water and less than 5 ppm chloride.
